(19) United States
(12) Patent Application Publication
(10) Pub. No.: US 2025/0353254 A1
(43) Pub. Date: Nov. 20, 2025

(54) MULTI-MATERIAL LIQUID BASED 3D PRINTING FOR FULL SHOE MANUFACTURING

(71) Applicant: adidas AG, Herzogenaurach (DE)

(72) Inventors: Meng ZHAO, Herzogenaurach (DE); Marc NORRIDGE, Fuerth (DE); Maximilian DREXLER, Wilhermsdorf (DE); Tru LE, Herzogenaurach (DE)

(21) Appl. No.: 19/209,285

(22) Filed: May 15, 2025

(30) Foreign Application Priority Data
May 17, 2024 (DE) 10 2024 113 875.0

(51) Int. Cl. B29C 64/30; A43C 15/16; B29C 64/124; B29C 64/336; B29C 64/343; B29C 64/393; B29L 31/50; B33Y 10/00; B33Y 40/20; B33Y 50/02; B33Y 80/00

(52) U.S. Cl. CPC B29C 64/30; B29C 64/124; B29C 64/336; B29C 64/343; B29C 64/393; B33Y 10/00; B33Y 40/20; B33Y 50/02; B33Y 80/00; A43C 15/16; B29K 2995/007; B29K 2995/0077; B29L 2031/50

(57) ABSTRACT

A method of printing a three-dimensional object, comprises at least the steps of providing at least a first and a second printing material separated in at least a first and a second material tank; providing a build platform; a first printing step of printing the object at least partially onto the build platform with the first printing material; a cleaning step of cleaning the object from the first and/or second printing material; and a second printing step of printing the object at least partially onto the build platform with the second printing material.

### CROSS REFERENCE TO RELATED APPLICATIONS

This application claims priority to German Patent Application No. 10 2024 113 875.0, filed May 17, 2024, which is incorporated by reference herein in its entirety.

### TECHNICAL FIELD

The present disclosure relates to a method of printing a three-dimensional object by providing at least a first and a second printing material separated in at least a first and a second material tank.

### BACKGROUND

In the 3D printing industry, printing processes utilizing Digital Light Processing (“DLP”) and photopolymerization are often confined to use only one type of material per printing job, which limits the overall material use in traditional 3D printing. Parts printed from only one material often lack the functional and/or aesthetic requirements necessary in more complex applications. The printing methods that use multiple materials per printing jobs are often times cumbersome and costly, as these demand meticulous processing and assembly. Common 3D printing methods also often create and waste excess material, which is not just expensive, but also reduces manufacturing sustainability. A further drawback in the traditional printing method is the management of material residues remaining on the product, which can decrease the quality of the final products.

With traditional 3D printing methods, material use is limited or the printing method is unnecessarily cumbersome and meticulous. Also, these methods create and waste excess material and leave material residues on the product. Thus, there is a demand for an improved method of 3D printing.

In view of the foregoing, there is a need for an improved 3D printing method.

### BRIEF SUMMARY

The present disclosure is directed to a system and method for printing a three-dimensional object via 3D printing. The system and method can comprise at least two material tanks to contain at least a first printing material and a second printing material. A build plate can provide a platform on which a three-dimensional object can be printed. The build plate can be configured to move between the two material tanks such that the three-dimensional object can be printed using the first printing material and the second printing material. The system and method can comprise a cleaning tank containing a cleaning material located between the first material tank and the second material tank. The three-dimensional object can be cleaned by the cleaning material as it moves between the first material tank and the second material tank.

A first embodiment (I) of the present disclosure is directed to a method of printing a three-dimensional object, comprising: providing at least a first printing material and a second printing material separated in at least a first material tank and a second material tank; providing a build platform; printing the three-dimensional object at least partially onto the build platform with the first printing material; cleaning the three-dimensional object; and printing the three-dimensional object at least partially onto the build platform with the second printing material.

In a second embodiment (II), in the method of the first embodiment (I), cleaning the three-dimensional object comprises: providing one or more cleaning tanks with a cleaning solution; providing one or more air knifes; providing one or more standing waves of cleaning solution; cleaning the three-dimensional object by exposing it to the one or more standing waves of cleaning solution; and drying the cleaned three-dimensional object by exposing it to the one or more air knifes.

In a third embodiment (III), in the method of the first embodiment (I), cleaning the three-dimensional object comprises: providing one or more cleaning tanks with a cleaning solution, wherein at least one of the one or more cleaning tanks is an ultrasonic cleaning tank; providing one or more air knifes; cleaning the three-dimensional object by immersing the three-dimensional object into the ultrasonic cleaning tank; and drying the cleaned three-dimensional object by exposing it to the one or more air knifes.

In a fourth embodiment (IV), in the method of any one of embodiments (I)-(III), at least one of the first material tank, the second material tank, or at least one of the cleaning tanks is horizontally movable.

In a fifth embodiment (V), in the method of any one of embodiments (I)-(IV), at least one of the first material tank, the second material tank, or at least one of the cleaning tanks is arranged on a rotatable disk.

In a sixth embodiment (VI), in the method of any one of embodiments (II)-(V), the at least one or more cleaning tanks is arranged between the first material tank and the second material tank.

In a seventh embodiment (VII), in the method of any one of embodiments (I)-(VI), the build platform is vertically and horizontally movable.

In an eighth embodiment (VIII), in the method of any one of embodiments (I)-(VII), the build platform comprises a Stewart platform.

In a ninth embodiment (IX), in the method of any one of embodiments (I)-(VIII), at least one of the first printing material or the second printing material is a liquid photopolymer resin.

In a tenth embodiment (X), in the method of any one of embodiments (I)-(IX), printing the three-dimensional object is performed utilizing Digital Light Processing (DLP).

In an eleventh embodiment (XI), in the method of any one of embodiments (I)-(X), printing the three-dimensional object is carried out by photopolymerization.

In a twelfth embodiment (XII), in the method of the eleventh embodiment (XI), the photopolymerization is enabled by UV light.

In a thirteenth embodiment (XIII), in the method of any one of embodiments (I)-(XII), the first printing material and the second printing material differ in their mechanical properties.

In a fourteenth embodiment (XIV), in the method of any one of embodiments (I)-(XIII), the first printing material has a Shore A hardness greater than or equal to 70 and less than or equal to 80.

In a fifteenth embodiment (XV), in the method of any one of embodiments (I)-(XIV), the first printing material has an elongation at break greater than or equal to 240% and less than or equal to 360%.

In a sixteenth embodiment (XVI), in the method of any one of embodiments (I)-(XV), the first printing material has a tear strength greater than or equal to 20 kN/m and less than or equal to 30 kN/m.

In a seventeenth embodiment (XVII), in the method of any one of embodiments (I)-(XVI), the second printing material has a Shore D hardness greater than or equal to 68 and less than or equal to 74.

In an eighteenth embodiment (XVIII), in the method of any one of embodiments (I)-(XVII), the second printing material has a tensile modulus greater than or equal to 1000 MPa and less than or equal to 1200 MPa.

In a nineteenth embodiment (XIX), in the method of any one of embodiments (I)-(XVIII), the second printing material has an elongation at break greater than 50%.

In a twentieth embodiment (XX), in the method of any one of embodiments (I)-(XIX), a filling level of the first printing material in the first material tank is controlled by a control means to maintain a constant filling level.

In a twenty-first embodiment (XXI), the method of the twentieth embodiment (XX) comprises estimating a tank refill volume based on a volume of a printing layer.

In a twenty-second embodiment (XXII), in the method of any one of embodiments (XX)-(XXI), the filling level of the first printing material in the first material tank is greater than or equal to 0.5 mm and less than or equal to 4 mm.

In a twenty-third embodiment (XXIII), in the method of any one of embodiments (XX)-(XXII), the filling level of the first printing material in the first material tank is a minimum volume necessary for printing of one layer.

In a twenty-fourth embodiment (XXIV), in the method of any one of embodiments (XX)-(XXIII), the control means comprises an overflow dam.

In a twenty-fifth embodiments (XXV), in the method of any one of embodiments (XX)-(XXIV), the control means comprises a non-contact fill level sensor, the non-contact fill level sensor comprising an ultrasonic transducer and/or a laser.

In a twenty-sixth embodiment (XXVI), in the method of any one of embodiments (XX)-(XXV), the control means comprises a weight sensor.

A twenty-seventh embodiment (XXVII) is directed to a sports article manufactured according to the method of any one of embodiments (I)-(XXVI).

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the present disclosure is generally described in the context of these embodiments, it should be understood that it is not intended to limit the scope of the present disclosure to these particular embodiments. In the drawings, like reference numbers indicate identical or functionally similar elements.

Possible embodiments of the present disclosure are disclosed by reference to the accompanying figures.

FIG. 1 shows a method of printing a three-dimensional object with a horizontally moveable build platform in a schematic view, according to some embodiments.

FIG. 2 shows a method of printing a three-dimensional object with a printing container in a schematic view, according to some embodiments.

FIG. 3 shows a method of printing a three-dimensional object with a rotatable disk in a schematic view, according to some embodiments.

FIG. 4 shows a common method of printing a three-dimensional object with a high fill level.

FIG. 5 shows a method of printing a three-dimensional object with a lower fill level in a schematic view, according to some embodiments.

FIG. 6 shows a method of printing a three-dimensional object with an overflow dam in a schematic view, according to some embodiments.

FIG. 7 illustrates a cleated shoe, according to some embodiments.

FIG. 8 illustrates a shin guard, according to some embodiments.

FIG. 9 illustrates a shoe, according to some embodiments.

FIG. 10 illustrates a shoe sole, according to some embodiments.

FIG. 11 illustrates a vertically integrated shoe sole, according to some embodiments.

FIG. 12 shows a method of printing a three-dimensional object where a build platform passes a cleaning tank after a first printing step in a schematic view, according to some embodiments.

FIG. 13 shows the method of FIG. 12, where the build platform passes the cleaning tank after a second printing step in a schematic view, according to some embodiments.

FIG. 14 shows a method of printing a three-dimensional object where the build platform passes an ultrasonic cleaning tank in a schematic view, according to some embodiments.

FIG. 15 shows a flowchart of a method of printing a three-dimensional object according to some embodiments.

### DETAILED DESCRIPTION

The subsequent sections provide a detailed description of the invention, referencing the accompanying illustrations for clarity. The descriptions represent examples only and are not intended to limit the scope of the present disclosure. Identical reference numerals across the figures and text denote the same components. The illustrations may not reflect actual size or scale; their dimensions, proportions, and depictions of elements might be enhanced for better understanding and visual convenience.

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

The term “component” according to the present disclosure may refer to, but is not limited to, a unit or module that performs a specific function within a larger system. A component may be, for example, a component used in the manufacturing process of a sporting good, such as a sole unit, a midsole, an outsole, an outsole element, a film or foil material, a sole plate, a shoe upper, a functional element.

An aspect of the present disclosure relates to a method of printing a three-dimensional object, comprising at least the steps: providing at least a first printing material and a second printing material separated in at least a first material tank and a second material tank; providing a build platform; a first printing step of printing the three-dimensional object at least partially onto the build platform with the first printing material; a cleaning step of cleaning the three-dimensional object from the first and/or second printing material; and a second printing step of printing the three-dimensional object at least partially onto the build platform with the second printing material.

This method can be particularly useful in applications where different properties, such as color, strength, or thermal resistance, are needed in different parts of the finished three-dimensional object. For example, a manufacturer can use a flexible material for the core of a part and a more sturdy, colorful material for the outer layers to enhance aesthetic appeal and functionality. This method can allow for high precision in multi-material 3D printing, reducing material waste and increasing the efficiency of the printing process by cleaning the three-dimensional object between steps, which can help maintain the quality and integrity of the finished product. A step of printing the three-dimensional object at least partially onto the build platform can comprise printing on a partially printed three-dimensional object that is attached to the build platform.

Another aspect of the present disclosure can be realized when the cleaning step comprises at least the steps: providing one or more cleaning tanks with a cleaning solution; providing one or more air knifes; and providing one or more standing waves of cleaning solution; cleaning the three-dimensional object by exposing it to the one or more standing waves of cleaning solution; and drying the cleaned three-dimensional object by exposing it to the one or more air knifes.

Such a cleaning step can offer a highly efficient way to ensure that each layer of the printed three-dimensional object is free from contamination before the next material is applied, which is important for maintaining the structural integrity and aesthetic quality of the final product. For instance, such thorough cleaning can prevent material mixing that might otherwise compromise functionality and/or aesthetics. The combination of standing waves and air knives can provide a thorough and gentle cleaning, suited for complex shapes or delicate details.

Another aspect of the present disclosure can be achieved when the cleaning step comprises at least the steps: providing one or more cleaning tanks with a cleaning solution, wherein at least one of the cleaning tanks is an ultrasonic cleaning tank, configured and dedicated for ultrasonic cleaning; and providing one or more air knifes; cleaning the three-dimensional object by immersing the three-dimensional object into the ultrasonic cleaning tank; and drying the cleaned three-dimensional object by exposing it to the one or more air knifes.

Such a cleaning step can be very beneficial in applications requiring high levels of purity and precision. Ultrasonic cleaning ensures thorough removal of residues and contaminants. This method not only can enhance the structural and surface integrity of the printed three-dimensional object but also can improve the bonding and layering of different materials in subsequent printing steps, as there is less contaminated material within the layers, thus leading to a higher quality and more reliable final product. The method of printing a three-dimensional object can be further improved when at least one of the material tanks and/or at least one of the cleaning tanks is horizontally movable.

This feature can enhance the efficiency and flexibility of the printing process. For example, in a large-scale manufacturing setting, where multiple objects or parts of an object need to be printed simultaneously or sequentially, the ability to move tanks horizontally can reduce the time taken to change materials or initiate cleaning cycles. This adaptability can be advantageous in production lines that require rapid changes between different types of materials or frequent cleaning of objects. The mobility of the tanks can also lead to better space management within the printing facility, optimizing the overall workflow and reducing operational downtime.

Further improvement of the method can be achieved when the tanks are arranged on a rotatable disk.

Such an arrangement can be beneficial in environments where rapid production and high throughput are important. For example, in industrial applications where multiple colors or material properties are required within short production timelines, the rotatable disk can enable a fast changeover between tanks, thus reducing downtime. Additionally, this method can enhance the precision of the material handling process, ensuring that the correct material or cleaning solution is readily available at the exact time it is needed.

Such a method can be improved further when at least one cleaning tank is arranged between the printing material tanks.

Such a configuration can be advantageous in settings where multiple material properties are important to the functionality of the object. The central placement of the cleaning tank can help maintain a high-quality print by ensuring that each material adheres properly without contamination from previous other materials. Additionally, this arrangement can optimize the workflow by minimizing the movement required between different stages of the printing process, leading to a faster production and reduced operational costs.

The method can be further improved when the build platform is vertically and horizontally movable.

Such a vertically and horizontally movable build platform can be beneficial in the production of complex, multi-layered objects where precise layer alignment is needed for structural integrity and functional performance. This adaptability not only can enhance the quality of the final product but also can allow for the production of more complex geometries that might not be feasible with a fixed platform, thus expanding the capabilities of the 3D printing method.

This method can be further improved when the build platform comprises a Stewart platform.

The incorporation of a Stewart platform can be useful for manufacturing contexts where great precision is required. The capability to finely tune the platform's orientation and position can ensure that each layer of a 3D printed object adheres correctly and with the appropriate alignment relative to other layers, thus improving the structural integrity and functional precision of the final product. Additionally, such a configuration can accommodate complex printing trajectories and material deposition patterns, which can be necessary for creating advanced geometries and structures with high performance and reliability.

Further improvement can achieved when at least one of the printing materials is a liquid photopolymer resin.

Utilizing a liquid photopolymer resin can be advantageous for applications requiring high detail and smooth surface finishes. The precision that can be achieved with photopolymer resins can be superior to many other 3D printing materials, allowing for the creation of parts with complex geometries and fine features that would be difficult to achieve with more traditional materials. Furthermore, photopolymer resins can be formulated with various properties, including different colors, transparencies, and mechanical characteristics, enhancing the versatility and applicability of the 3D printing process across various industries.

Even further improved method can be realized when the printing utilizes Digital Light Processing (DLP).

Employing DLP in the 3D printing process can be beneficial for creating parts that require high-speed production without sacrificing detail and accuracy. The ability of DLP to cure entire layers simultaneously can allow for faster creation of complex, high-resolution structures compared to other printing methods that require more time. Additionally, DLP technology can be optimized for use with a wide range of photopolymer resins, allowing for variations in material properties such as flexibility, strength, and opacity, thus expanding the scope and versatility of 3D printed applications.

Even more improvement can be achieved when the printing is carried out by photopolymerization.

Utilizing photopolymerization in the 3D printing process can offer distinct advantages for producing highly detailed and accurate parts. The ability to precisely control the light exposure can allow for complex designs with smooth surfaces and intricate details that might not be achievable through more traditional manufacturing methods. Additionally, photopolymerization can be used with a range of different resins, each offering different mechanical and thermal properties, enabling the production of customized items tailored to specific functional requirements and environmental conditions.

Further improvements can be obtained when the photopolymerization is enabled by UV light.

Utilizing UV light for photopolymerization, for example in a DLP-based 3D printing system, can provide several advantages. Firstly, UV light can cure specific resins very quickly, enhancing the speed of the printing process, which is important in high-throughput production. Moreover, the use of UV light can allow for very fine control over the curing process, enabling the production of parts with extremely fine details and high dimensional accuracy. This method can also support the use of a wide array of UV-curable resins, allowing for customization of material properties to fit specific applications.

Further improvement can be achieved when the first printing material and the second printing material differ in their mechanical properties.

Such an approach can be advantageous when components require areas of differing rigidity and flexibility within a single part. The ability to print with materials that have varied mechanical properties in a single printing session can also enhance product design and innovation, allowing the production of parts that are both lightweight and durable, or rigid in some areas while elastic in others. This can not only simplify the manufacturing process by reducing the need for assembly of multiple parts but can also open new possibilities for designing products that are more complex and functionally integrated.

The method can be further improved when the first printing material has a Shore A hardness greater than or equal to 70 and less than or equal to 80. Unless specified otherwise herein, Shore A hardness refers to a hardness of the first printing material after printing of the object is completed.

A material with a Shore A hardness greater than or equal to 70 and less than or equal to 80 can be suitable for applications that require a balance between flexibility and structural strength. This level of hardness can be suitable for parts which need to withstand physical stress and deformation without breaking. The use of such a material in 3D printing can allow for creating parts that can endure bending and flexing while still maintaining their shape and integrity. This characteristic can be beneficial when components must frequently withstand dynamic stresses and yet provide reliable performance.

Even more improvement can be obtained when the first printing material has an elongation at break greater than or equal to 240% and less than or equal to 360%. Unless specified otherwise herein, elongation at break refers to an elongation at break of the first printing material or the second printing material after printing of the object is completed.

Such an elongation capacity can make the first printing material particularly suitable for producing parts that need to sustain extensive deformation under load without rupturing or parts subject to frequent stretching and compressing. The combination of a Shore A hardness greater than or equal to 70 and less than or equal to 80 with high elongation at break can provide a material that is not only tough and resistant to tearing but also highly adaptable to dynamic mechanical conditions.

This can be further improved when the first printing material has a tear strength greater than or equal to 20 kN/m and less than or equal to 30 kN/m. Unless specified otherwise herein, tear strength refers to a tear strength of the first printing material after printing of the object is completed.

Combining moderate Shore A hardness (greater than or equal to 70 and less than or equal to 80), high elongation at break (greater than or equal to 240% and less than or equal to 360%), and substantial tear strength (greater than or equal to 20 kN/m and less than or equal to 30 kN/m) can make the first printing material suitable for manufacturing parts that are exposed to harsh conditions. The properties of the first printing material can ensure that such parts can perform reliably without failure, thus providing safety and longevity.

The method can also be improved when the second material has a Shore D hardness greater than or equal to 68 and less than or equal to 74. Unless specified otherwise herein, Shore D hardness refers to a hardness of the second printing material after printing of the object is completed.

The second material having such a level of hardness can be suitable for applications requiring high structural integrity and resistance to mechanical stress and deformation. The combination of for example the first printing material's flexibility and the second printing material's hardness can allow for the fabrication of composite objects that are both resilient and durable, optimizing performance across varied operational demands.

Further improvement can be achieved when the second printing material has a tensile modulus (for example, Young's modulus, which quantifies the elasticity of a material) greater than or equal to 1000 MPa and less than or equal to 1200 MPa. Unless specified otherwise herein, tensile modulus refers to a tensile modulus of the second printing material after printing of the object is completed.

Such a range of tensile modulus can make the second printing material suitable for structural applications where rigidity and the ability to bear loads without excessive deformation are important. These kinds of applications can benefit from the second printing material's high stiffness, ensuring that structural components can maintain their shape and functionality under mechanical stress and contribute to the overall integrity and safety of the system. Such a material, with a Shore D hardness of greater than or equal to 68 and less than or equal to 74 and a tensile modulus of greater than or equal to 1000 MPa and less than or equal to 1200 MPa, complements the more flexible first printing material, allowing for a balanced combination of properties in the final printed object.

Further improvement can be obtained when the second printing material has an elongation at break greater than 50%. Unless specified otherwise herein, elongation at break refers to an elongation at break of the first printing material or the second printing material after printing of the object is completed.

Such a characteristic can make the second printing material suited for components that must endure both static and dynamic stresses. The combination of a Shore D hardness of greater than or equal to 68 and less than or equal to 74, a tensile modulus greater than or equal to 1000 MPa and less than or equal to 1200 MPa, and an elongation at break greater than 50% can provide a robust material profile, suitable for manufacturing parts that are expected to perform reliably under varying operational conditions. This ensures that the parts can support loads while also accommodating movements and minor deformations.

Examples of the first printing material and the second printing material can include commonly known printing materials like elastomeric polyurethane (“EPU”) 43, EPU 44, EPU 45, EPU 46, LOCTITE® 3D IND405 Clear, rigid polyurethane (“RPU”) 70, urethane methacrylate (“UMA”) 90 and/or other suitable materials. The choice of materials can also be dependent on the desired properties, e.g to achieve toughness and/or stiffness with Polyamides (“PA”) or to achieve varying hardness, elasticity and damping with thermoplastic Polyurethane (“TPU”).

To improve the method even further, the filling level of the printing material (for example the first printing material or the second printing material) in the material tank (for example the first material tank or the second material tank) can be controlled by a control means to maintain a constant filling level.

The ability to maintain a constant filling level in the material tanks can be beneficial when printing large or complex structures. The control means can comprise sensors that monitor the printing material level and adjust it by adding printing material from a reserve when levels drop, or by stopping the addition when the optimal level is reached. This automated adjustment can help in achieving a high degree of precision in the final product, optimizing the use of materials, and reducing waste, thereby enhancing the overall efficiency and cost-effectiveness of the manufacturing process.

This can be further achieved when the method comprises an estimation of a material tank refill volume based on a volume of a printing layer.

Estimating the material tank refill volume can be advantageous for maintaining efficiency and material consistency in continuous or high-volume printing operations. Being able to accurately calculate and replenish the exact amount of material used per layer can help in avoiding both shortages, which can pause or stop the printing process, and overfills, which could lead to material waste or spillage. This approach can not only enhance the precision of the printing process but also can optimize material usage, reducing overall production costs and minimizing waste.

To improve this method more, the filling level of the printing material in the material tank can be controlled by a control means to be greater than or equal to 0.5 mm and less than or equal to 4 mm. In some embodiments, the filling level of the printing material in the material tank can be controlled by the control means to be greater than or equal to 1 mm and less than or equal to 2 mm.

Maintaining such a filling level range can be particularly important in applications requiring extreme precision and uniformity in material deposition. The specified range can ensure that the printing mechanism has optimal access to the material. Additionally, such precise control can help maintain consistent viscosity and temperature of the material. Through its enhanced control mechanism, such a method can contribute to the reliability and efficiency of the printing process.

To improve this method even further, the filling level of the printing material in the material tank can be controlled by a control means to be at the minimum volume necessary for printing of one layer.

Such a method can be beneficial for high-precision manufacturing processes where material efficiency and layer quality are paramount. Maintaining the minimum necessary volume for each layer can minimize the risk of material degradation due to prolonged exposure to environmental factors and can reduce the overall material costs by avoiding excess usage. This approach can not only enhance the sustainability of the printing process by conserving resources but can also ensure that each layer is consistently printed with fresh material, which can improve the structural integrity and resolution of the final product. This material management can help to achieve a high standard required in advanced manufacturing applications.

Further improvement of this method can be achieved when the control means comprises an overflow dam.

Including an overflow dam can be advantageous in 3D printing setups. By preventing overfilling, the overflow dam can help to maintain a consistent material flow to the printer head, which can be necessary for achieving uniform layer deposition. Additionally, the overflow dam can aid in reducing material waste by catching any excess that could otherwise spill or be wasted, thus improving the efficiency and cost-effectiveness of the printing process. An overflow dam can also help in maintaining a clean and controlled printing environment by containing spills and splashes, thus enhancing the operational reliability and maintenance ease of the printing equipment.

This method can be improved even further when the control means comprises a non-contact fill level sensor, the sensor comprising an ultrasonic transducer and/or a laser.

A non-contact sensor can provide an improved printing setup, as by detecting the fill level with a non-contact sensor, the fill level surveillance can be seamlessly implemented in the printing setup. This way, the control means can be enabled to control the filling level of a material tank to maintain a constant level.

Even further improvement of this method can be achieved when the control means comprises a weight sensor.

A weight sensor can enable another possibility of measuring the fill level of a material tank by knowing the total weight of the material inside the tank. This can provide the opportunity to control the fill level with precision.

Another part of the present disclosure is a sports article manufactured according to the method.

The method according to the present disclosure can be suited to manufacture sports articles, as these often require the materials and manufacturing methods utilizing the foregoing parameters.

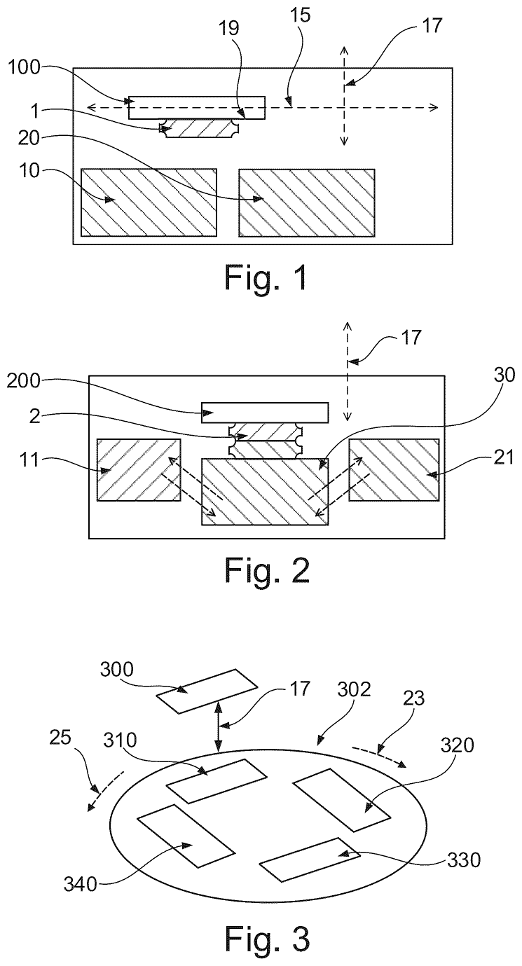

FIG. 1 illustrates a printing setup according to the present disclosure to print a three-dimensional object 1. In some embodiments, the build platform 100 can be movable in a horizontal direction 15 and a vertical direction 17. The printed three-dimensional object 1 can be printed on a bottom side 19 of the build platform 100. In some embodiments, a first material tank 10 and a second material tank 20 can be supplied, the first material tank 10 containing a first printing material and the second material tank 20 containing a second printing material. The build platform 100 can readily switch between the first material tank 10 and the second material tank 20 to print a three-dimensional object from different materials.

In some embodiments, the build platform 100 can seamlessly alternate between the first material tank 10 and the second material tank 20, enabling the integration of different materials into the three-dimensional object 1. This capability can be particularly useful for creating complex objects that require varied material properties (e.g., hardness, flexibility, color and the like) at different sections of the final product. The setup shown in FIG. 1 can allow for enhanced product functionality and aesthetic qualities by incorporating multiple materials (for example, the first printing material and the second printing material) into a single object without the need for manual intervention or assembly post-printing. Thus, the manufacturing process for multi-material items can be streamlined, where material properties can be optimized for specific functional zones within the three-dimensional object 1. In some embodiments, the printing materials can be liquid photopolymer resin. In some embodiments, the 3D printing can utilize Digital Light Processing (DLP). In some embodiments, the 3D printing can be carried out by photopolymerization and the photopolymerization can be enabled by UV light.

FIG. 2 shows a printing setup according to the present disclosure to print a three-dimensional object 2. In some embodiments, a build platform 200 can be movable in the vertical direction 17. In some embodiments, a printing container 30 can be arranged below the build platform 200. In some embodiments, a first printing material 11 a second printing material 21 can be introduced into the printing container 30, depending on which printing material should be used to print a layer of the three-dimensional printing object.

In some embodiments, the printing container 30 can be designed to be able to hold both the first printing material 11 and the second printing material 21. In some embodiments, the first printing material 11 and the second printing material 21 can be alternately introduced into the printing container 30 based on the specific requirements of each layer of the three-dimensional object 2 being printed. This configuration can allow for efficient switching between materials during the printing process, which can facilitate the creation of complex multi-material objects without the need to pause and manually change or mix materials. In some embodiments, the printing setup shown in FIG. 2 can be particularly advantageous for producing layers with varying material properties in a continuous printing process.

In FIG. 3, a build platform 300 can be moveable in the vertical direction 17 and can be arranged over a rotatable disk 302. In some embodiments, the rotatable disk 302 can be configured to rotate in a clockwise direction 23 and can contain a first material tank 310, a second material tank 320, a third material tank 330 and a cleaning tank 340. In some embodiments, the rotatable disk 302 can be configured to rotate in a counterclockwise direction 25. In some embodiments, the rotatable disk 302 can be configured to rotate in both the clockwise direction 23 and the counterclockwise direction 25. Depending on a rotational position of the rotatable disk 302 relative to the build platform 300, a different tank can be utilized for printing.

In some embodiments, the rotatable disk 302 can support the operational flexibility of the printing setup of FIG. 3 and can enable the build platform 300 to access different materials or perform cleaning operations by rotating the rotatable disk 302 to the desired position. For example, during the printing process, the build platform 300 can vertically align with any of the material tanks to deposit different materials as required by the design of a printed three-dimensional object. In some embodiments, the build platform 300 can vertically align with the cleaning tank 340 to ensure the printed three-dimensional object or the build platform 300 itself is free from any residue before a new material is applied. Such a configuration can be suited for manufacturing processes where products require the integration of multiple materials with differing properties. In some embodiments, the inclusion of the cleaning tank 340 can prevent cross-contamination between different material layers.

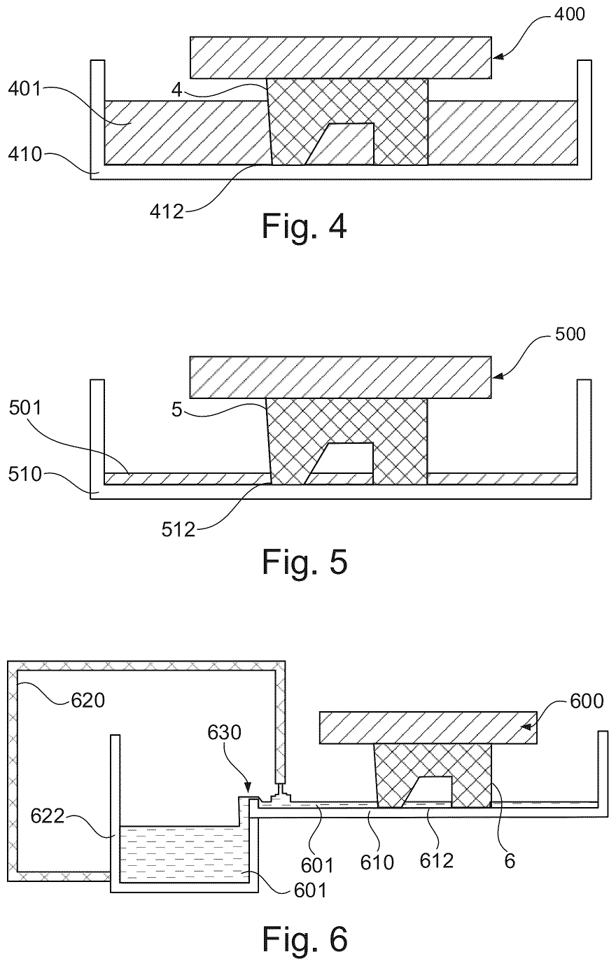

FIG. 4 shows a conventional printing method of a three-dimensional object 4. A build platform 400 contains a three-dimensional object 4, which is nearly completely immersed in a printing material 401 inside a printing material tank 410. A printing layer is printed on the object 4 near the bottom 412 of the printing material tank 410. In this conventional printing method, more than half of the object 4 is covered by the printing material 401.

The object 4 is built upside down and each new layer is cured by a light source at the bottom of the printing material tank 410 as the build platform 400 gradually lifts the object 4 upward, exposing the newly solidified layer and submerging the next layer into the printing material 401 (for example, liquid resin for printing). The immersion in the printing material 401 makes it harder to clean the object 4 prior to a second printing step in another printing material, as all the printing material 401 needs to be cleaned of the object 4 to avoid cross contamination between printing materials.

FIG. 5 shows a printing setup according to the present disclosure. In some embodiments, a build platform 500 contains a three-dimensional object 5, which is barely immersed in a printing material 501 inside a material tank 510. In some embodiments, a printing layer can be printed on the object 5 near the bottom 512 of the material tank 510. In some embodiments, just a small portion of the three-dimensional object 5 is covered by the printing material 501, and there is just enough printing material 501 to print a layer. This setup can reduce cleaning effort because only as much material as necessary to print a layer is in contact with the three-dimensional object 5. In some embodiments, a filling level of the printing material 501 in the material tank 510 can be controlled by a control means to maintain a constant filling level. In some embodiments, maintaining a constant filling level can be achieved utilizing an estimation of a tank refill volume based on a volume of a printing layer. In some embodiments, the filling level of the printing material 501 in the material tank 510 can be controlled by a control means to be greater than or equal to 0.5 mm and less than or equal to 4 mm above the bottom 512 of the material tank 510. In some embodiments, the filling level of the printing material 501 in the material tank 510 can be controlled by a control means to be greater than or equal to 1 mm and less than or equal to 2 mm above the bottom 512 of the material tank 510. In some embodiments, the filling level of the printing material 501 in the material tank 510 can be controlled by a control means to be at a minimum volume necessary for printing of one layer. In some embodiments, the control means can comprise a non-contact fill level sensor (for example, an ultrasonic transducer and/or a laser can be used to determine a height of the printing material 501 in the material tank 510 such that the material tank 510 can be filled with the printing material 501 until the height of the printing material 501 in the material tank 510 reaches a predetermined height as determined by the non-contact fill level sensor). In some embodiments, the control means can comprise a weight sensor (for example, the material tank 510 can be filled with the printing material 501 until the weight of the printing material 501 in the material tank 510 reaches a predetermined weight as sensed by the weight sensor).

The printing setup shown in FIG. 5 can reduce the cleaning effort needed between layers and after the completion of the print. For example, by limiting the immersion depth of the three-dimensional object 5, less of the three-dimensional object 5 encounters the printing material 501, thereby reducing residue and potentially decreasing the instances of imperfections caused by excess material sticking to the three-dimensional object 5. Furthermore, the printing setup show in FIG. 5 can enhance the efficiency of material use, as only the necessary amount of the printing material 501 required for each layer is in contact with the object, thereby minimizing or reducing waste. The printing setup of FIG. 5 can be advantageous for manufacturing processes where post- or mid-processing cleaning efforts are desired to be minimized or reduced. The printing setup of FIG. 5 not only can support a cleaner and more efficient printing process but also can contribute to sustainability by reducing material waste.

FIG. 6 shows a printing setup according to the present disclosure. In some embodiments, a build platform 600 can contain the three-dimensional object 6, which is barely immersed in a printing material 601 inside a material tank 610. In some embodiments, a printing layer can be printed on the three-dimensional object 6 near the bottom 612 of the material tank 610. The printing material 601 can be stored in a reservoir 622 from where it is transferred into the material tank 610 by a material transfer unit 620. An overflow dam 630 can keep the fill level in the material tank 610 constant, as excess material can flow over the overflow dam 630 and back into the reservoir 622.

In the example embodiment of FIG. 6, just a small portion of the three-dimensional object 6 is covered by the printing material 601. This can reduce cleaning efforts because only as much of the printing material 601 as necessary to print a layer is in contact with the three-dimensional object 6. This can be beneficial, as the printing setup of FIG. 6 can ensure a steady supply of the printing material 601 without overfilling the material tank 610, thus maintaining the quality of each printed layer. The minimal immersion of the three-dimensional object 6 in the printing material 601, combined with the overflow dam 630 and recycling of the material, can significantly reduce the cleaning effort, and can enhance the efficiency of the process. The printing setup of FIG. 6 can be advantageous in scenarios where material consistency is important. Additionally, the controlled environment provided by the printing setup of FIG. 6 can reduce the risk of contamination (for example, with other printing materials), and can ensure that only the necessary amount of the printing material 601 contacts the three-dimensional object 6, thus maintaining cleanliness and accuracy. The printing setup of FIG. 6 can not only optimize material use but can also contribute to a more sustainable and cost-effective manufacturing process.

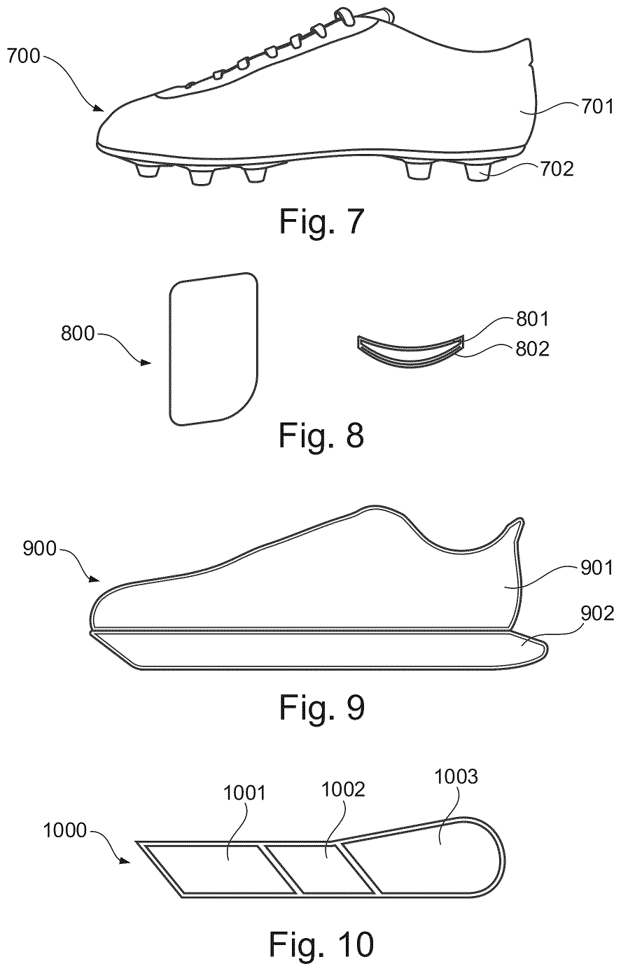

In FIG. 7, a cleated shoe 700 printed using any one of the printing setups and methods according to the present disclosure is depicted. In some embodiments, a shoe upper 701 and a cleated sole 702 can be printed by different materials using any one of the printing setups according to the present disclosure.

Specific design and material properties can be tailored for different sports or user preferences, providing enhanced performance characteristics such as improved shock absorption, better traction, or increased comfort.

FIG. 8 depicts a shin guard 800 printed using any one of the printing setups and methods according to the present disclosure. In some embodiments, an inner layer 801 can be printed with a different material than an outer layer 802 using any one of the printing setups according to the present disclosure.

In some embodiments, the inner layer 801, which can be in direct contact with the wearer's skin, can be printed using a softer, more flexible material to ensure comfort and cushion against impacts. This material can be lightweight and can be capable of conforming to the contours of the wearer's leg, providing a snug fit that can maximize protection while maintaining comfort. In some embodiments, the outer layer 802 can be designed to absorb and distribute the force of impacts during sports or other activities. For this purpose, a tougher, more rigid material can be used to resist punctures and scratches, ensuring that the shin guard can remain effective over time under harsh usage conditions. This dual-material printing technique exemplifies the ability of the printing setups and methods disclosed herein to produce complex, multi-functional sports equipment in a single, streamlined process. By integrating different material properties within the same item, the shin guard can be optimized for both protection and comfort without the need for additional assembly processes.

In FIG. 9, a shoe 900 that can be printed using any one of the printing setups and methods according to present disclosure is illustrated. In some embodiments, a shoe upper 901 and a sole 902 can be printed using different materials using any one of the printing setups and methods according to the present disclosure.

In some embodiments, the shoe upper 901, which encases the foot, can be printed from a material that offers flexibility, breathability, and comfort. This could be a soft material that molds to the shape of the wearer's foot, providing a comfortable fit while also allowing for air circulation to keep the foot cool and dry. In some embodiments, the sole 902 can be printed from a more durable and robust material that can withstand the abrasions and stresses of walking or running. This material can provide sufficient traction and support, possibly incorporating varying densities and textures that can optimize grip and cushioning, and can enhance the performance and longevity of the shoe 900. Using different materials for different parts of the shoe 900 showcases the advanced capabilities of the printings setups and methods disclosed herein for 3D printing various products, allowing for extensive customization and optimization of the product. By precisely controlling the material properties using any of the printing setups and methods disclosed herein, the shoe 900 can be tailored to specific activities or wearer preferences, providing an excellent fit, targeted support, and optimal comfort. In some embodiments, a first material (for example, the material offering flexibility, breathability, and comfort) can have a Shore A hardness greater than or equal to 70 and less than or equal to 80. In some embodiments, the first material can have an elongation at break greater than or equal to 240% and less than or equal to 360%. In some embodiments, the first material can have a tear strength greater than or equal to 20 kN/m and less than or equal to 30 kN/m. In some embodiments, a second material (for example, the material offering more durability and robustness) can have a Shore D hardness greater than or equal to 68 and less than or equal to 74. In some embodiments, the second material can have a tensile modulus greater than or equal to 1000 MPa and less than or equal to 1200 MPa. In some embodiments, the second material can have an elongation break greater than 50%.

FIG. 10 illustrates a sole 1000 printed using any one of the printing setups and methods according to the present disclosure. In some embodiments, the sole 1000 can comprise different materials (for example, a first sole material 1001, a second sole material 1002, and a third sole material 1003).

In some embodiments, the first sole material 1001 can be designed to provide cushioning and shock absorption, which can be useful for areas of the sole that bear the effect of impact during activities like walking or running. In some embodiments, the first sole material 1001 can be a soft, resilient polymer that compresses under pressure but quickly returns to its original shape. In some embodiments, the second sole material 1002 can be used for its durability and wear resistance, which can be useful for an outer perimeter of the sole 1000 that comes into frequent contact with the ground. In some embodiments, the second sole material 1002 can be a tougher, more abrasion-resistant material that withstands long-term use without degrading. In some embodiments, the third sole material 1003 can be selected for its grip and traction properties, which can be useful in areas of the sole 1000 that require anti-slip characteristics to ensure safety and performance on various surfaces. This method of using different materials within a single sole exemplifies the versatility and precision of advanced 3D printing techniques. The printing setups and methods in any one of the embodiments disclosed herein can allow for the tailoring of each section of the sole 1000 according to specific functional requirements, which can optimize the overall performance of the footwear. By segmenting the sole 1000 into zones with tailored material properties (for example, a first zone comprising the first sole material 1001, a second zone comprising the second sole material 1002, and a third zone comprising the third sole material 1003), the sole 1000 can offer enhanced comfort, longevity, and safety, which can be important for high-performance footwear.

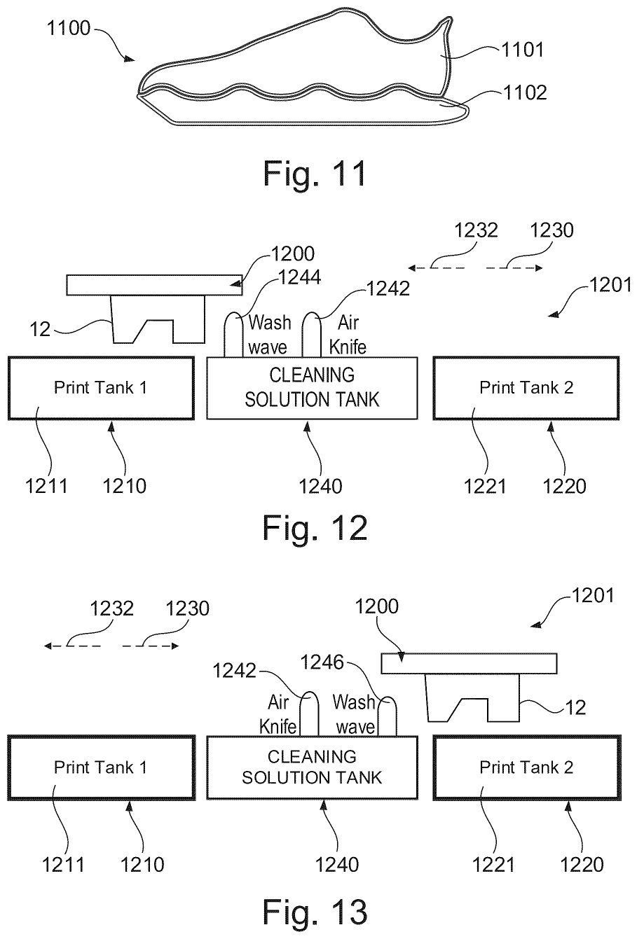

In FIG. 11, a shoe 1100 printed using any one of the printing setups and methods disclosed herein is illustrated. In some embodiments, a shoe upper 1101 and a sole 1102 can be printed using different materials. In some embodiments, the shoe upper 1101 and the sole 1102 are not only horizontally connected, but can also be in vertical engagement with each other.

In some embodiments, the vertical engagement involves some form of interlocking design, where elements of the sole 1102 and the shoe upper 1101 mesh or fit together (for example, like puzzle pieces), thereby enhancing the strength and durability of the connection. In some embodiments, the interlocking design can be achieved through complementary ridges and grooves, snaps, or other mechanical fastenings that can be directly printed into the materials. Having an interlocking design can ensure that the shoe upper 1101 and the sole 1102 can not only be adhered together but also can be structurally integrated, which can significantly improve the overall stability and durability of the shoe 1100. Such a design can enhance the integrity and performance of the shoe 1100 by ensuring that the two parts can effectively distribute and withstand the stresses and strains experienced during wear. As compared to a shoe without an interlocking design, the interlocking design of the shoe 1100 can better absorb impact, provide enhanced support, and reduce the likelihood of separation or wear at the joining point, which can be a weak spot in traditionally manufactured footwear.

FIGS. 12-13 show a printing setup 1201 at different points during a 3D printing process, according to some embodiments. In some embodiments, the printing setup 1201 can comprise a first material tank 1210 that contains a first printing material 1211 and a second material tank 1220 that contains a second printing material 1221. In some embodiments, the first printing material 1211 and the second printing material 1221 can be different materials having different material properties based on the desired properties of, for example, a three-dimensional object 12. In some embodiments, a cleaning tank 1240 that contains a cleaning solution can be located between the first material tank 1210 and the second material tank 1220. In some embodiments, the printing setup 1201 can comprise a build platform 1200 configured to secure the three-dimensional object 12 as the three-dimensional object 12 is being printed. In some embodiments, the build platform 1200 can be configured to move in a first direction 1230 and a second direction 1232.

In some embodiments, the three-dimensional object 12 can comprise the first printing material 1211 and the second printing material 1221 in various layers. To apply the layers of the first printing material 1211 and the second printing material 1221, the build platform 1200 can be configured to move between a first position that is vertically above the first material tank 1210 and a second position that is vertically above the second material tank 1220. In some embodiments, when the build platform 1200 is in the first position one or more layers of the first printing material 1211 can be printed on to the three-dimensional object 12 and/or the build platform 1200. In some embodiments, when the build platform 1200 is in the second position one or more layers of the second printing material 1221 can be printed on the three-dimensional object 12 and/or the build platform 1200.

In some embodiments, it can be beneficial to clean the three-dimensional object 12 by removing excess material and/or debris from the three-dimensional object 12 as the build platform moves between the first position and the second position. For example, in some embodiments the cleaning tank 1240 can comprise a first standing wash wave 1244 and a second standing wash wave 1246. In some embodiments, the first standing wash wave 1244 and the second standing wash wave 1246 can comprise portions of the cleaning solution that are located vertically above the remainder of the cleaning solution. In some embodiments, the first standing wash wave 1244 and the second standing wash wave 1246 can be generated by agitating the cleaning tank 1240 to generate travelling waves of the cleaning solution that interfere with each other. In some embodiments, the first standing wash wave 1244 and the second standing wash wave 1246 can be generated at different times such that only one of the first standing wash wave 1244 or the second standing wash wave 1246 can be present at a given time.

In some embodiments, as the build platform 1200 moves from the first position to the second position, the first standing wash wave 1244 can clean the three-dimensional object 12 to remove debris and/or excess material. As the build platform 1200 continues to move toward the second position, the three-dimensional object 12 can pass through an air knife 1242 configured to blow air over the three-dimensional object 12 to remove the cleaning solution and any residual printing material from the three-dimensional object 12 to dry the three-dimensional object 12 prior to reaching the second position.

After reaching the second position, the second printing material 1221 can be applied to the three-dimensional object 12 and/or the build platform 1200. The build platform 1200 can then move from the second position to the first position, during which the three-dimensional object 12 can be cleaned by the second standing wash wave 1246 and dried by the air knife 1242.

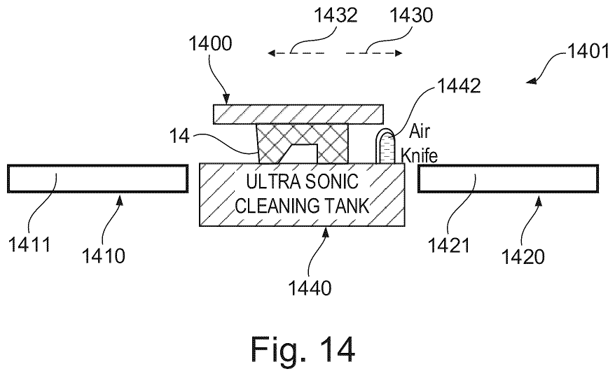

FIG. 14 shows a printing setup 1401, according to some embodiments. In some embodiments, the printing setup 1401 can comprise a first material tank 1410 that contains a first printing material 1411 and a second material tank 1420 that contains a second printing material 1421. In some embodiments, the first printing material 1211 and the second printing material 1221 can be different materials having different material properties based on the desired properties of, for example, a three-dimensional object 14. In some embodiments, an ultrasonic cleaning tank 1440 that contains a cleaning solution can be located between the first material tank 1410 and the second material tank 1420. In some embodiments, the printing setup 1401 can comprise a build platform 1400 configured to secure the three-dimensional object 14 as the three-dimensional object 14 is being printed. In some embodiments, the build platform 1400 can be configured to move in a first direction 1430 and a second direction 1432.

In some embodiments, the three-dimensional object 14 can comprise the first printing material 1411 and the second printing material 1421 in various layers. To apply the layers of the first printing material 1411 and the second printing material 1421, the build platform 1400 can be configured to move between a first position that is vertically above the first material tank 1410 and a second position that is vertically above the second material tank 1420. In some embodiments, when the build platform 1400 is in the first position one or more layers of the first printing material 1411 can be printed on to the three-dimensional object 12 and/or the build platform 1400. In some embodiments, when the build platform 1400 is in the second position one or more layers of the second printing material 1421 can be printed on the three-dimensional object 14 and/or the build platform 1400.

In some embodiments, after printing the three-dimensional object 14 partially on the build platform 1400, the build platform 1400 with the three-dimensional object 14 can move to the right (for example, in the first direction 1430) toward the second material tank 1420. On its way it passes the ultrasonic cleaning tank 1440, which can comprise an air knife 1442. In some embodiments, the build platform 1400 can be moved vertically (for example, lowered) into the ultrasonic cleaning tank 1440, so that the three-dimensional object 14 can be immersed in the cleaning solution inside the ultrasonic cleaning tank 1440 to clean the three-dimensional object 14. In some embodiments, the ultrasonic cleaning tank 1440 uses high-frequency sound waves to agitate the cleaning fluid, which generates micro-cavitation bubbles in the cleaning fluid. These bubbles can effectively remove any debris, residual printing material, or contaminants from the surface of the three-dimensional object 14, thereby providing a deep clean that is highly effective for intricate designs and complex geometries.

After the ultrasonic cleaning is complete, the build platform 1400 can be moved upwards, so that the three-dimensional object 14 emerges from the ultrasonic cleaning tank 1440. The build platform 1400 can continue to move to the right (in the first direction 1430) toward the second material tank 1420. On its way it passes the air knife 1442. In some embodiments, the air knife 1442 can direct a high-velocity stream of air onto the three-dimensional object 14, effectively drying it by removing any remaining moisture or cleaning fluid residues. This step prepares the object's surface for the application of the second printing material, ensuring that subsequent layers adhere properly. As described, the build platform 1400 can move in both the vertical and horizontal directions. In some embodiments, the build platform 1400 can be a Stewart platform to enable the vertical and horizontal movement.

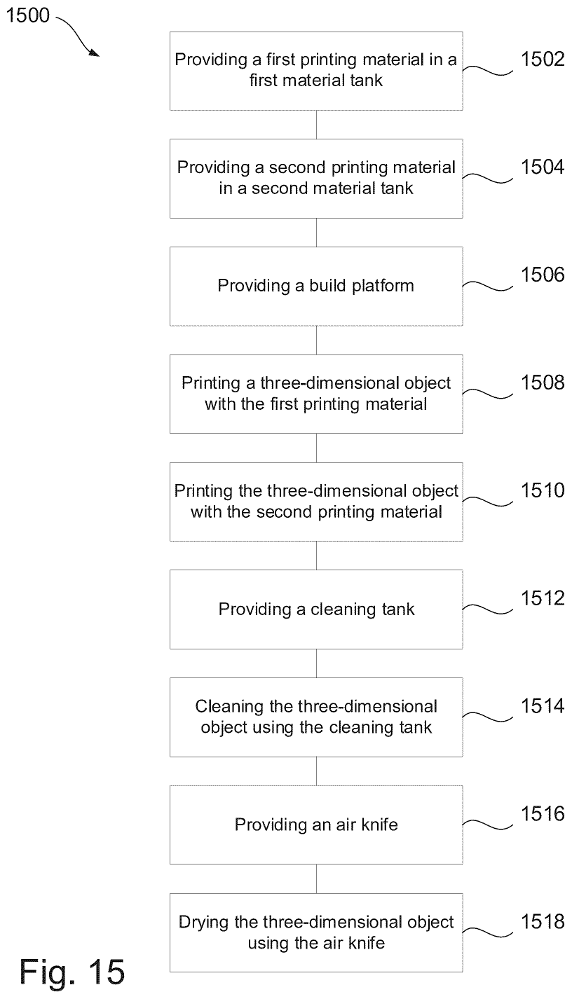

FIG. 15 shows a flowchart of a method 1500 of printing a three-dimensional object according to some embodiments. In some embodiments, the method 1500 can be used to print any of the three-dimensional objects disclosed herein.

At step 1502, a first printing material can be provided in a first material tank. For example, any of the first printing material 11, 1211, 1411 can be provided in any one of the first material tank 10, 310, 1210, 1410.

At step 1504, a second printing material can be provided in a second material tank. For example, any of the second printing material 21, 1221, 1421 can be provided in any one of the second material tank 20, 320, 1220, 1420.

At step 1506, a build platform is provided. In some embodiments, the build platform can provide a surface on which a three-dimensional object can be built (via, for example, 3D printing). For example, any of the build platform 100, 200, 300, 500, 600, 1200, 1400 can be provided.

At step 1508, a three-dimensional object can be at least partially printed with the first printing material. For example, any of the three-dimensional object 1, 2, 5, 6, 12, 14 can be at least partially printed on any of the build platform 100, 200, 300, 500, 600, 1200, 1400 using any of the first printing material 11, 1211, 1411.

At step 1510, the three-dimensional object can be at least partially printed with the second printing material. For example, any of the three-dimensional object 1, 2, 5, 6, 12, 14 can be at least partially printed on any of the build platform 100, 200, 300, 500, 600, 1200, 1400 using any of the second printing material 21, 1221, 1421.

At step 1512, a cleaning tank can be provided. For example, any of the cleaning tank 340, 1240, 1440 can be provided. In some embodiments, any of the cleaning tank 340, 1240, 1440 can be provided in between any of the first material tank 10, 310, 1210, 1410 and any one of the second material tank 20, 320, 1220, 1420.

At step 1514, the three-dimensional object can be cleaned using the cleaning tank. For example, any of the three-dimensional object 1, 2, 5, 6, 12, 14 can be cleaned by a cleaning solution contained within any of the cleaning tank 340, 1240, 1440.

At step 1516, an air knife can be provided. For example, any of the air knife 1242, 1442 can be provided between any of the of the first material tank 10, 310, 1210, 1410 and any one of the second material tank 20, 320, 1220, 1420.

At step 1518, the three-dimensional object can be dried using the air knife. For example, any of the three-dimensional object 1, 2, 5, 6, 12, 14 can be dried by any one of the air knife 1242, 1442.

In some embodiments, the steps 1512-1518 can be performed after step 1508, after step 1510, or both.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

The examples are illustrative, but not limiting, of the present disclosure. Other suitable modifications and adaptations of the variety of conditions and parameters normally encountered in the field, and which would be apparent to those skilled in the art, are within the spirit and scope of the present disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents

What is claimed is:

1. A method of printing a three-dimensional object, the method comprising:
providing at least a first printing material and a second printing material separated in at least a first material tank and a second material tank;
providing a build platform;
printing the three-dimensional object at least partially onto the build platform with the first printing material;
cleaning the three-dimensional object; and
printing the three-dimensional object at least partially onto the build platform with the second printing material.

2. The method according to claim 1, wherein cleaning the three-dimensional object comprises:
providing one or more cleaning tanks with a cleaning solution;
providing one or more air knifes;
providing one or more standing waves of cleaning solution;
cleaning the three-dimensional object by exposing it to the one or more standing waves of cleaning solution; and
drying the cleaned three-dimensional object by exposing it to the one or more air knifes.

3. The method according to claim 1, wherein cleaning the three-dimensional object comprises:
providing one or more cleaning tanks with a cleaning solution, wherein at least one of the one or more cleaning tanks is an ultrasonic cleaning tank;
providing one or more air knifes;
cleaning the three-dimensional object by immersing the three-dimensional object into the ultrasonic cleaning tank; and
drying the cleaned three-dimensional object by exposing it to the one or more air knifes.

4. The method according to claim 2, wherein at least one of the first material tank, the second material tank, or at least one of the cleaning tanks is horizontally movable.

5. The method according to claim 2, wherein at least one of the first material tank, the second material tank, or at least one of the cleaning tanks is arranged on a rotatable disk.

6. The method according to claim 2, wherein at the least one or more cleaning tanks is arranged between the first material tank and the second material tank.

7. The method according to claim 1, wherein the build platform is vertically and horizontally movable.

8. The method according to claim 1, wherein the first printing material and the second printing material differ in their mechanical properties.

9. The method according to claim 8, wherein the first printing material has a Shore A hardness greater than or equal to 70 and less than or equal to 80 after printing of the three-dimensional object is complete.

10. The method according to claim 8, wherein the first printing material has an elongation at break greater than or equal to 240% and less than or equal to 360% after printing of the three-dimensional object is complete.

11. The method according to claim 8 to, wherein the first printing material has a tear strength greater than or equal to 20 kN/m and less than or equal to 30 kN/m after printing of the three-dimensional object is complete.

12. The method according to claim 8, wherein the second printing material has a Shore D hardness greater than or equal to 68 and less than or equal to 74 after printing of the three-dimensional object is complete.

13. The method according to claim 8, wherein the second printing material has a tensile modulus greater than or equal to 1000 MPa and less than or equal to 1200 MPa after printing of the three-dimensional object is complete.

14. The method according to claim 8, wherein the second printing material has an elongation at break greater than 50% after printing of the three-dimensional object is complete.

15. The method according to claim 1, wherein a filling level of the first printing material in the first material tank is controlled by a control means to maintain a constant filling level.

16. The method according to claim 15, wherein the filling level of the first printing material in the first material tank is greater than or equal to 0.5 mm and less than or equal to 4 mm.

17. The method according to claim 15, wherein the filling level of the first printing material in the first material tank is a minimum volume necessary for printing of one layer.

18. The method according to claim 15, wherein the control means comprises an overflow dam.

19. The method according to claim 15, wherein the control means comprises a non-contact fill level sensor, the non-contact fill level sensor comprising an ultrasonic transducer and/or a laser.

20. The method according to claim 15, wherein the control means comprises a weight sensor.
